(19) United States
(12) Patent Application Publication
(10) Pub. No.: US 2017/0017037 A1
(43) Pub. Date: Jan. 19, 2017

(54) Optical Apparatus

(71) Applicants: Sintai Optical (Shenzhen) Co., Ltd., Shenzhen City (CN); Asia Optical International Ltd., Tortola (GB)

(72) Inventors: Chia-Tse Sun, Taichung (TW); Bo-Syung Yang, Taichung (TW); Bin-Huang Yang, Taichung (TW)

(21) Appl. No.: 15/206,551

(22) Filed: Jul. 11, 2016

(30) Foreign Application Priority Data
Jul. 17, 2015 (TW) 104123155

(51) Int. Cl. G02B 6/293; G02B 3/04; G02B 27/30; G02B 3/00; G02B 6/34; G02B 6/42

(52) U.S. Cl. CPC G02B 6/2938; G02B 6/34; G02B 6/4214; G02B 6/4215; G02B 27/30; G02B 3/0043; G02B 3/04; G02B 6/4244; G02B 6/424

(57) ABSTRACT

An optical apparatus includes a prism, a plurality of filter elements, a plurality of lenses, a light receiver array, a collimator lens and a base. The prism includes a light entering surface and a light exit surface parallel to each other. The filter elements are disposed on the light exit surface. The lenses correspond to the filter elements. The light receiver array includes a plurality of light receivers which correspond to the lenses. The light signal including a plurality of sub-signals enters the prism through the light entering surface. The sub-signals are separated from the light signal by the filter elements and exit from the light exit surface of the prism, and each of the sub-signals is transmitted through one of the lenses to one of the light receivers. The base is a continuous-unitary piece for positioning other elements.

### BACKGROUND OF THE INVENTION

Field of the Invention

The invention relates to an optical apparatus, and more particularly to an optical apparatus which includes a prism for mounting filter elements and a continuous-unitary base for positioning other optical elements, thereby simplifying the assembly of the optical apparatus.

Description of the Related Art

Referring to FIG. 1, a known optical multiplexer 1 includes a base 2, a plurality of collimator lenses 4a-4l and a plurality of filter lenses 6a-6k. In operation, a light signal Lin enters the optical multiplexer 1 through the collimator lens 4a. Sub-signals L1-L10 of different wave lengths are successively separated from the light signal Lin and individually received by different collimator lenses 4b-4k. Eventually, a light signal Lout exits from the optical multiplexer 1 through the collimator lens 4l.

However, the filter lenses 6a-6k of the known optical multiplexer 1 have no datum plane to rely on when mounted on the base 2, which is liable to faulty assembly and the assembly is time-consuming and the manufacturing cost is increased. Both the yield rate and production capacity are affected in mass production. Further, the distances between the collimating lenses 4a-4l are fixed, which is disadvantageous to modification of the design of the optical multiplexer.

### BRIEF SUMMARY OF THE INVENTION

To address the shortcomings discussed, the invention provides an optical apparatus, wherein the filter elements are disposed on a surface of a prism, which is used as a datum plane. The main body of the base of the optical apparatus and the support portions for supporting optical elements are continuous-unitary. The relative locations of the support portions are determined according to the design requirements of the optical apparatus. Therefore, the assembly of the optical apparatus can be accomplished by mounting the optical elements on the support portions, and also the optical apparatus is able to meet the design requirements.

The optical apparatus in accordance with an exemplary embodiment of the invention includes a prism, a plurality of filter elements, a plurality of lenses, a light receiver array, a collimator lens and a base. The prism includes a light entering surface and a light exit surface parallel to each other. The filter elements are disposed on the light exit surface. The lenses correspond to the filter elements. The light receiver array includes a plurality of light receivers which correspond to the lenses. The light signal including a plurality of sub-signals enters the prism through the light entering surface. The sub-signals are separated from the light signal by the filter elements and exit from the light exit surface of the prism, and each of the sub-signals is transmitted through one of the lenses to one of the light receivers. The base includes a main body, a first support portion, a second support portion and a third support portion, wherein the first support portion, the second support portion and the third support portion are disposed on the main body, the collimator lens is supported by the first support portion, the prism is supported by the second support portion, the lenses are supported by the third support portion, the third support portion is integrally formed with the main body and the first support portion to be a continuous unitary piece, and the light signal comprising the sub-signals is transmitted through the collimator lens to the prism.

In another exemplary embodiment, the second support portion is a first surface and the prism is mounted and positioned on the first surface.

In yet another exemplary embodiment, the third support portion is further integrally formed with the lenses to be the continuous unitary piece.

In another exemplary embodiment, the base further includes a fourth support portion by which the light receiver array is supported.

In yet another exemplary embodiment, the fourth support portion is a second surface and the light receivers are disposed on the second surface.

In another exemplary embodiment, the fourth support portion is a foundation and the light receivers are disposed on the foundation.

In yet another exemplary embodiment, the filter elements are attached to the light exit surface.

In another exemplary embodiment, the lenses are aspheric lenses.

In yet another exemplary embodiment, the lenses have different curvatures.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a known optical multiplexer.

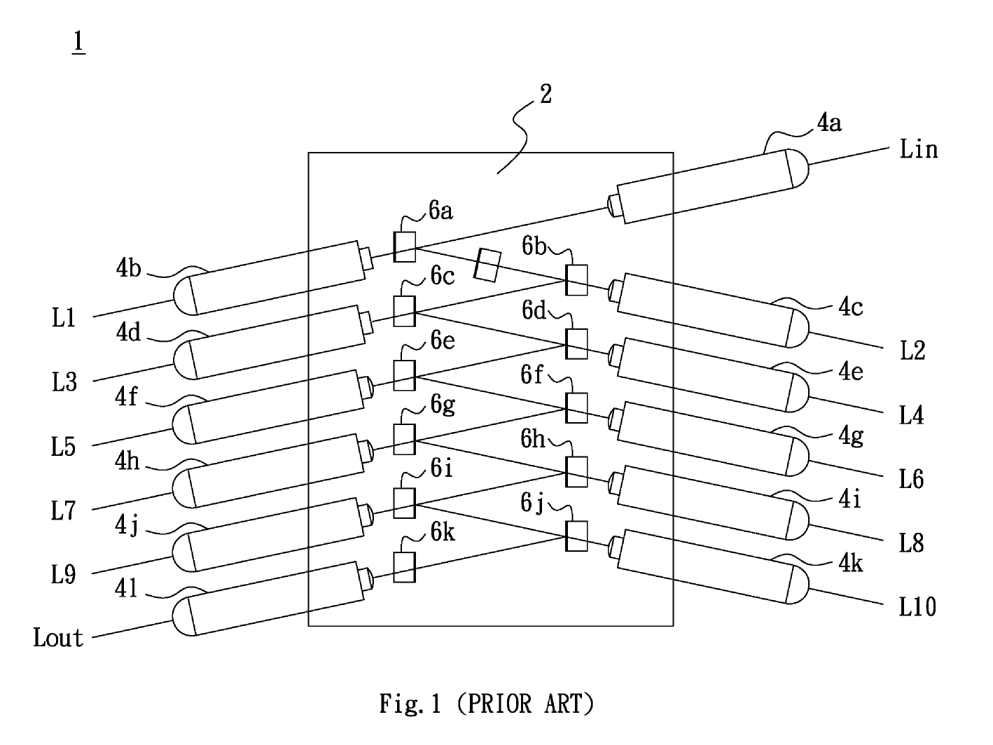

FIG. 2 is a schematic view showing an optical apparatus in accordance with an embodiment of the invention.

FIG. 3 is a side view of the optical apparatus of FIG. 2.

FIG. 4 is a schematic view showing an optical apparatus in accordance with another embodiment of the invention.

FIG. 5 is a side view of the optical apparatus of FIG. 4.

### DETAILED DESCRIPTION OF THE INVENTION

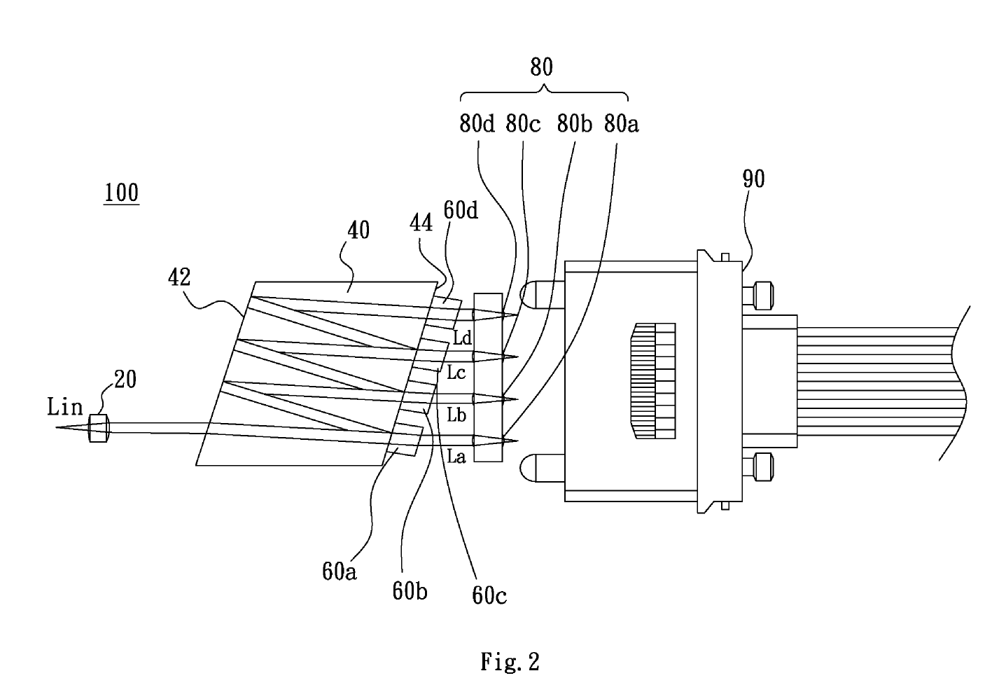

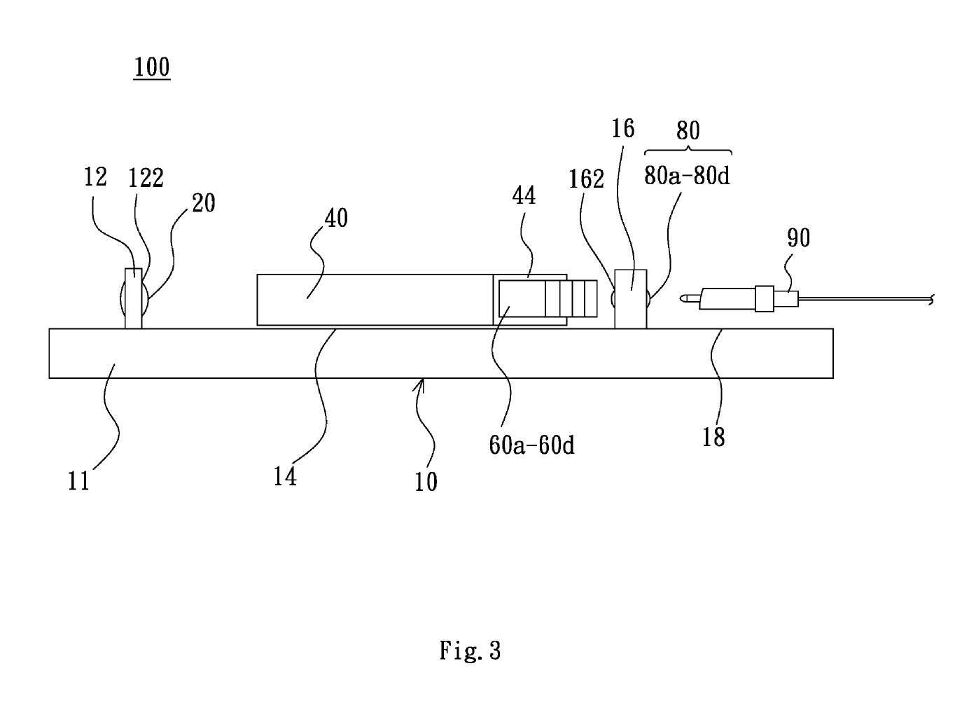

Referring to FIGS. 2 and 3, an optical apparatus 100 of an embodiment of the invention includes a base 10, a collimating lens 20, a prism 40, a plurality of filter elements 60a, 60b, 60c and 60d, a lens array 80 and a light receiver array 90. The prism 40 is diamond and has a light entering surface 42 and a light exit surface 44. The light entering surface 42 and the light exit surface 44 are parallel to each other. The filter elements 60a, 60b, 60c and 60d are attached to the light exit surface 44. The lens array 80 includes a plurality of lenses 80a, 80b, 80c and 80d. The light receiver array 90 includes a plurality of light receivers corresponding to the lenses 80a, 80b, 80c and 80d. In this embodiment, the filter elements 60a, 60b, 60c and 60d are filter lenses. The light receivers are optical fibers. In operation, a light signal Lin enters the optical apparatus 100 through the collimating lens 20, enters the prism 40 through the light entering surface 42, and is totally reflected between the light entering surface 42 and the light exit surface 44 many times wherein the light entering surface 42 and the light exit surface 44 are parallel to each other. Each time the light signal Lin reaches the light exit surface 44, a sub-signal is separated from the light signal by one filter element. Thus, sub-signals La-Ld of different wave lengths are successively separated from the light signal Lin by the filter elements 60a-60d attached to the light exit surface 44 and exit from the light exit surface 44 of the prism 40. Afterwards, the sub-signals La-Ld enter the light receivers through the lenses 80a-80d.

The base 10 includes a main body 11, a first support portion 12, a second support portion 14, a third support portion 16 and a fourth support portion 18. The first support portion 12, the second support portion 14, the third support portion 16 and the fourth support portion 18 are disposed on the main body 11. The collimating lens 20 is supported by the first support portion 12. The prism 40 is supported by the second support portion 14. The lenses 80a-80d are supported by the third support portion 16. The light receiver array 90 is supported by the fourth support portion 18. In this embodiment, the first support portion 12 is a first bracket. The first bracket has a first hole 122 in which the collimating lens 20 is mounted and positioned. The third support portion 16 is a second bracket. The second bracket has a plurality of second holes 162 in which the lenses 80a-80d are mounted. The second support portion 14 is a first surface provided between the first support portion 12 and the second support portion 16. The prism 40 is mounted on the first surface. Specifically, the prism 40 is attached to or screwed to the first surface. The fourth support portion 18 is a second surface. The light receiver array 90 is positioned on the second surface and corresponds to the lenses 80a-80d. The first support portion 12, the second support portion 14, the third support portion 16 and the fourth support portion 18 are integrally formed with the main body 11 to be a continuous unitary piece. Therefore, the desired dimensions of the first support portion 12, the second support portion 14, the third support portion 16 and the fourth support portion 18 and the desired distances therebetween can be easily made. Further, the assembly of the optical apparatus 100 can be accomplished by respectively mounting the collimating lens 20, the prism 40, the lens array 80 and the light receiver array 90 on the first support portion 12, the second support portion 14, the third support portion 16 and the fourth support portion 18, and the optical apparatus 100 is capable of the desired optical performance without the requirements of any adjustments.

In another embodiment, the lenses 80a-80d are further integrally formed with the third support portion 16. That is, the lens array 80 and the base 10 are formed as a continuous unitary piece.

In the above embodiment, an optical multiplexer is taken as an example for describing the optical apparatus 100 of the invention. However, the invention is not limited to the use of an optical multiplexer. To the contrary, various optical apparatus having any of the described technical features belong to the category of the invention.

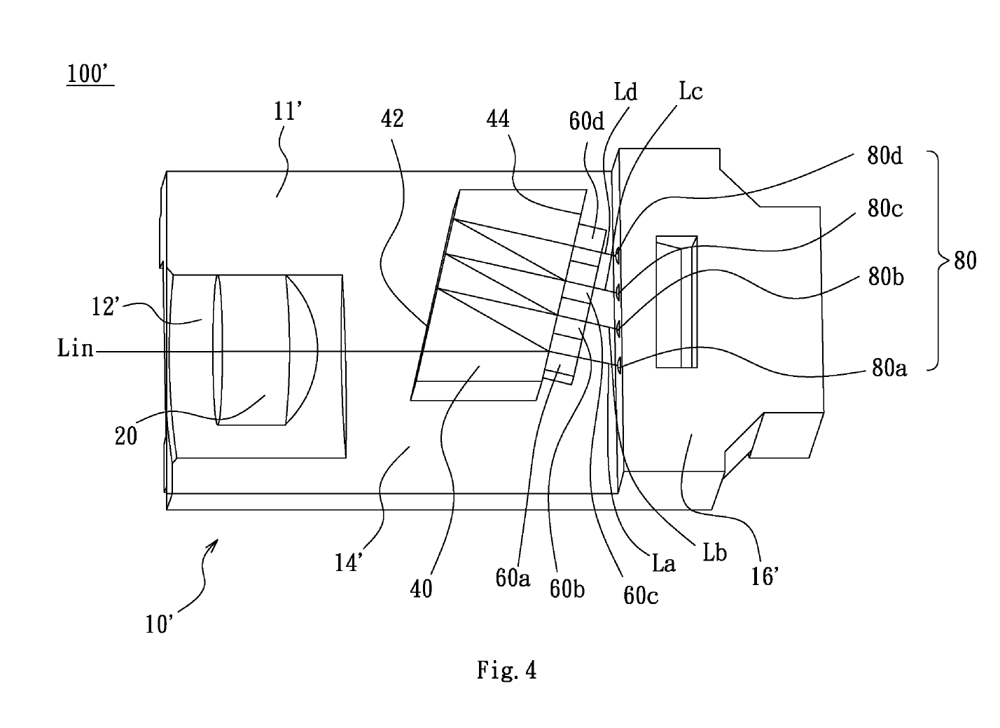

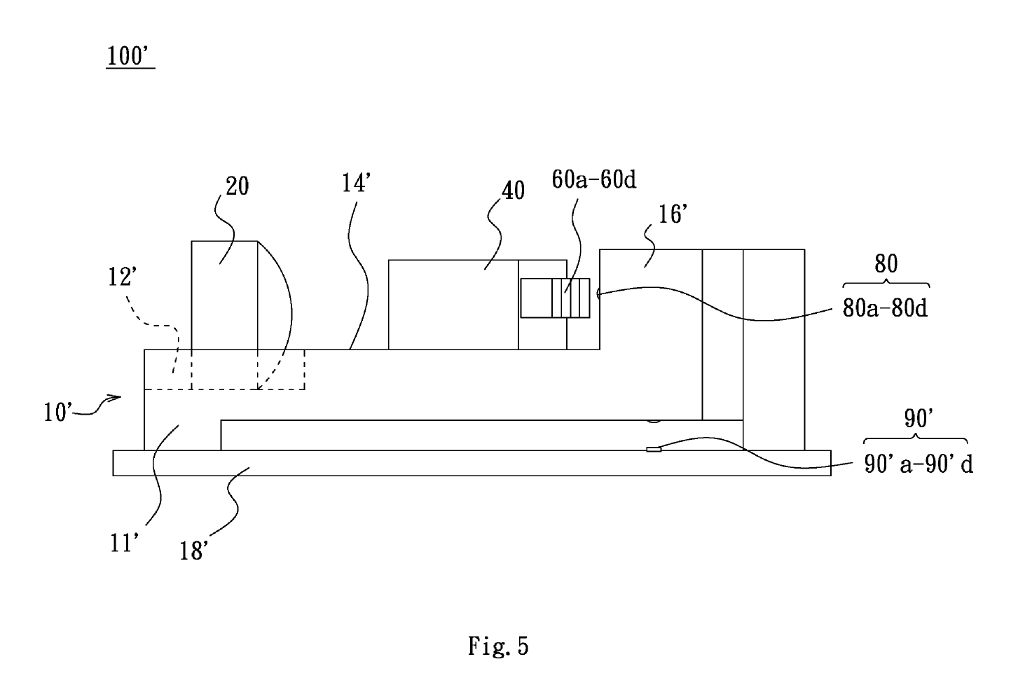

FIGS. 4 and 5 depict an optical apparatus 100′ of another embodiment of the invention, in which the elements same as those of FIGS. 2 and 3 are given the same reference numerals and the descriptions thereof are omitted. The optical apparatus 100′ includes a base 10′, a collimating lens 20, a prism 40, a plurality of filter elements 60a, 60b, 60c and 60d, a lens array 80 and a light receiver array 90′. The filter elements 60a, 60b, 60c and 60d in this embodiment, similar to those of FIGS. 2 and 3, are attached to the light exit surface 44 of the prism 40. The lens array 80 includes a plurality of lenses 80a, 80b, 80c and 80d. The light receiver array 90 includes a plurality of light receivers 90′a, 90′b, 90′c and 90′d. In this embodiment, the light receivers 90′a, 90′b, 90′c and 90′d are photodiodes. In operation, a light signal Lin enters the optical apparatus 100′ through the collimating lens 20, enters the prism 40 through the light entering surface 42, and is totally reflected between the light entering surface 42 and the light exit surface 44 many times wherein the light entering surface 42 and the light exit surface 44 are parallel to each other. Each time the light signal Lin reaches the light exit surface 44, a sub-signal is separated from the light signal by one filter element. Thus, sub-signals La-Ld of different wave lengths are successively separated from the light signal Lin by the filter elements 60a-60d attached to the light exit surface 44 and exit from the light exit surface 44 of the prism 40. Afterwards, the sub-signals La-Ld enter the light receivers 90′a-90′d through the lenses 80a-80d and the optical paths in the base 10′.

In this embodiment, the base 10′ includes a main body 11′, a first support portion 12′, a second support portion 14′, a third support portion 16′ and a fourth support portion 18′. The first support portion 12′, the second support portion 14′, the third support portion 16′ and the fourth support portion 18′ are disposed on the main body 11′. The collimating lens 20 is supported by the first support portion 12′. The prism 40 is supported by the second support portion 14′. The lenses 80a-80d are supported by the third support portion 16′. The light receivers 90′a-90′d are supported by the fourth support portion 18′. In this embodiment, the first support portion 12′ is a concave in which the collimating lens 20 is mounted and positioned. The second support portion 14′ is a flat surface. The prism 40 is disposed on the flat surface and positioned on the main body 11′. The third support portion 16′ is a bracket in which the lenses 80a-80d are mounted. The fourth support portion 18′ is a foundation provided under the main body 11′. The light receivers 90′a-90′d are mounted on the foundation and correspond to the lenses 80a-80d and the optical paths thereof.

The continuous-unitary base 10 and 10′ of the invention is able to expedite the assembly of the optical apparatus, reduce the number of the parts, shorten the assembly time to less than 1/10 of the assembly time of the conventional optical multiplexer, raise the yield rate, reduce the manufacturing cost, promote the accuracy of positioning the optical elements, and shorten the time for an optical correction. The dimensions of the assembled optical apparatus 100 and 100′ can be reduced that is advantageous to product testing and reduction of the cost of consumables. The spacing of the light receiving channels can be customized. The design of the optical apparatus is more flexible. The lenses 80a-80d may have different curvatures. Therefore, the light receiving efficiency can be greatly increased.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical apparatus, comprising:
a prism comprising a light entering surface and a light exit surface, wherein a light signal enters the prism through the light entering surface, and is totally reflected between the light entering surface and the light exit surface a plurality of times;
a plurality of filter elements disposed on the light exit surface;
a plurality of lenses corresponding to the filter elements;
a light receiver array comprising a plurality of light receivers which correspond to the lenses;
a collimator lens; and
a base comprising a main body and a first support portion, wherein the first support portion supporting the collimator lens is disposed on and formed with the main body to be a continuous unitary piece.

2. The optical apparatus as claimed in claim 1, wherein the optical apparatus further comprises a second support portion which supports the prism.

3. The optical apparatus as claimed in claim 2, wherein the second support portion is integrally formed with the prism to be the continuous unitary piece.

4. The optical apparatus as claimed in claim 2, wherein:
the light signal from the collimator lens enters the prism through the light entering surface, the sub-signals are separated from the light signal by the filter elements and exit from the light exit surface of the prism; and
the light entering surface and the light exit surface are parallel to each other.

5. The optical apparatus as claimed in claim 2, wherein the optical apparatus further comprises a third support portion supporting the lenses.

6. The optical apparatus as claimed in claim 5, wherein the third support portion is integrally formed with the lenses to be the continuous unitary piece.

7. The optical apparatus as claimed in claim 5, wherein:
the light signal from the collimator lens enters the prism through the light entering surface, the sub-signals are separated from the light signal by the filter elements and exit from the light exit surface of the prism and each of the sub-signals is transmitted to one of the lenses; and
the light entering surface and the light exit surface are parallel to each other.

8. The optical apparatus as claimed in claim 5, wherein the optical apparatus further comprises a fourth support portion supporting the light receiver array.

9. The optical apparatus as claimed in claim 8, wherein the fourth support portion is integrally formed with the light receiver array to be the continuous unitary piece.

10. The optical apparatus as claimed in claim 8, wherein:
the light signal from the collimator lens enters the prism through the light entering surface, the sub-signals are separated from the light signal by the filter elements and exit from the light exit surface of the prism, and each of the sub-signals is transmitted through one of the lenses to one of the light receivers; and
the light entering surface and the light exit surface are parallel to each other.

11. The optical apparatus as claimed in claim 1, wherein the filter elements are attached to the light exit surface.

12. The optical apparatus as claimed in claim 1, wherein the lenses which are aspheric have different curvatures.

13. The optical apparatus as claimed in claim 2, wherein the second support portion is a first surface and the prism is mounted and positioned on the first surface.

14. The optical apparatus as claimed in claim 3, wherein the second support portion is a first surface and the prism is mounted and positioned on the first surface.

15. The optical apparatus as claimed in claim 8, wherein the fourth support portion is a second surface and the light receivers are disposed on the second surface.

16. The optical apparatus as claimed in claim 9, wherein the fourth support portion is a second surface and the light receivers are disposed on the second surface.

17. The optical apparatus as claimed in claim 8, wherein the fourth support portion is a foundation and the light receivers are disposed on the foundation.

18. The optical apparatus as claimed in claim 9, wherein the fourth support portion is a foundation and the light receivers are disposed on the foundation.

19. The optical apparatus as claimed in claim 1, wherein the first support portion is integrally formed with the collimator lens to be the continuous unitary piece.

20. The optical apparatus as claimed in claim 8, wherein the main body, the first support portion, the second support portion, the third support portion and the fourth support portion are integrally formed to be the continuous unitary piece.
